(19) United States
(12) Patent Application Publication
(10) Pub. No.: US 2017/0277783 A1
(43) Pub. Date: Sep. 28, 2017

(54) ONTOLOGY PROCESSING DEVICE AND A NON-TRANSITORY COMPUTER-READABLE STORAGE MEDIUM

(71) Applicant: Oki Electric Industry Co., Ltd., Tokyo (JP)

(72) Inventor: Akihiro OKUMURA, Tokyo (JP)

(73) Assignee: Oki Electric Industry Co., Ltd., Tokyo (JP)

(21) Appl. No.: 15/404,648

(22) Filed: Jan. 12, 2017

(30) Foreign Application Priority Data
Mar. 28, 2016 (JP) 2016-063931

(51) Int. Cl. G06F 17/30; G06F 17/27

(52) U.S. Cl. CPC G06F 17/30734; G06F 17/2735; G06F 17/2705

(57) ABSTRACT

To assist in adding a more appropriate word to ontology having a superordinate concept and a subordinate concept. An ontology processing device according to an embodiment of the present disclosure acquires a word from ontology as a seed word, the word corresponding to a subordinate concept of a designated concept; computes a distance between a hyperplane obtained from a result of fitting processing on the seed word and a word corresponding to each of word vectors; extracts words serving as candidates on the basis of the computed distance, the candidates being additionally registered in the ontology; and adds a part or all of extracted addition candidate words to the ontology.

### CROSS REFERENCE TO RELATED APPLICATION(S)

This application is based upon and claims benefit of priority from Japanese Patent Application No. 2016-063931, filed on Mar. 28, 2016, the entire contents of which are incorporated herein by reference.

### BACKGROUND

The present invention relates to an ontology processing device and a non-transitory computer-readable storage medium.

Mechanical translation and dialogue understanding have been studied in language processing technologies for years in the past, and wide studies are conducted today on sophisticated knowledge processing using semantic information (concepts) on words. Those technologies include an ontology technology. “Ontology” is a kind of dictionary, and systematically sorts concepts of words. For example, the technology of Patent Literature 1 (JP 2009-110513A) is disclosed as a conventional technology of generating ontology.

In addition, Non-Patent Literature 1 (“Distributed representations of words and phrases and their compositionality” Tomas Mikolov, Ilya Sutskever, Kai Chen, Greg S Corrado, Jeff Dean, 2013, NIPS) has described in the past a technique of creating word vectors by being provided with and automatically learning a large number of provided documents. Although there has been a technology of creating vector representations from words, the technology described in Non-Patent Literature 1 is capable of representing complicated concepts. For example, it possible to perform an operation like “France”-“Paris”+“Tokyo”≈“Japan” with a created vector. In this case, “France”-“Paris” represents the “country having that city as the capital.” In this way, the direction of a vector has some “meaning” in Non-Patent Literature 1.

Further, Patent Literature 1 discloses the automatic generation of ontology using the similarity between words.

### SUMMARY

The technology of Patent Literature 1, however, generates ontology that places words on the same level, but cannot generate ontology having the relationship of superordinate concepts and subordinate concepts.

In view of such circumstances, it is desired to provide an ontology processing device and an ontology processing program that assist in adding a more appropriate word to ontology having superordinate concepts and subordinate concepts.

An ontology processing device according to an embodiment of the present invention includes: (1) a word vector retaining unit configured to retain a plurality of word vectors; (2) an ontology storage unit configured to store ontology; (3) a seed word acquisition unit configured to acquire a word from the ontology stored in the ontology storage unit as a seed word, the word corresponding to a subordinate concept of a designated word; (4) a distance computation unit configured to compute a distance between a hyperplane obtained from a result of fitting processing on the seed word and a word corresponding to each of the word vectors retained in the word vector retaining unit; (5) an addition candidate extraction unit configured to extract words serving as candidates from words corresponding to the plurality of word vectors retained in the word vector retaining unit on the basis of the distance computed by the distance computing unit, the candidates being additionally registered in the ontology of the ontology storage unit; and (6) an ontology editing unit configured to add a part or all of addition candidate words to the ontology of the ontology storage unit, the addition candidate words being extracted by the addition candidate extraction unit.

A non-transitory computer-readable storage medium according to an embodiment of the present invention stores an ontology processing program, the program causing a computer to function as: (1) a word vector retaining unit configured to retain a plurality of word vectors; (2) an ontology storage unit configured to store ontology; (3) a seed word acquisition unit configured to acquire a word from the ontology stored in the ontology storage unit as a seed word, the word corresponding to a subordinate concept of a designated word; (4) a distance computation unit configured to compute a distance between a hyperplane obtained from a result of fitting processing on the seed word and a word corresponding to each of the word vectors retained in the word vector retaining unit; (5) an addition candidate extraction unit configured to extract words serving as candidates from words corresponding to the plurality of word vectors retained in the word vector retaining unit on the basis of the distance computed by the distance computing unit, the candidates being additionally registered in the ontology of the ontology storage unit; and (6) an ontology editing unit configured to add a part or all of addition candidate words to the ontology of the ontology storage unit, the addition candidate words being extracted by the addition candidate extraction unit.

According to the present invention, it is possible to provide an ontology processing device and an ontology processing program that assist in adding a more appropriate word to ontology having superordinate concepts and subordinate concepts.

### BRIEF DESCRIPTION OF THE DRAWINGS

FIG. 1 is a block diagram illustrating a functional configuration of an ontology creation assistance device according to an embodiment;

FIG. 2 is a flowchart illustrating an operation of an ontology creation assistance device according to an embodiment;

FIG. 3 is an explanatory diagram (conceptual diagram) illustrating a configuration example of ontology into which an ontology creation assistance device according to an embodiment has added no word;

FIG. 4 is an explanatory diagram (conceptual diagram) illustrating a configuration example of ontology into which an ontology creation assistance device according to an embodiment has added a word;

FIG. 5 is an explanatory diagram illustrating a configuration example of a word vector of a seed word created by a word vector creation unit according to an embodiment;

FIG. 6 is an explanatory diagram illustrating a result of a contribution rate calculation conducted by a distance computation unit according to an embodiment;

FIG. 7 is an explanatory diagram illustrating a transform coefficient used to perform a rotation so as to fit coordinates into distribution of each seed word acquired by a distance computation unit according to an embodiment;

FIG. 8 is an explanatory diagram illustrating a word vector created by a word vector creation unit according to an embodiment;

FIG. 9 is an explanatory diagram illustrating a parameter obtained by rotating coordinates of a word vector created by a word vector creation unit according to an embodiment; and

FIG. 10 is an explanatory diagram illustrating a configuration example of an operation screen (an operation screen on which an addition candidate word is presented to a user, and a word to be added to ontology is received) displayed by an ontology editing unit according to an embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### (A) Primary Embodiment

The following describes an embodiment of an ontology processing device and an ontology processing program according to the present invention in detail with reference to the drawings. The following describes an example in which an ontology processing device and an ontology processing program according to an embodiment of the present invention are applied to an ontology creation assistance device.

### (A-1) Configuration According to Embodiment

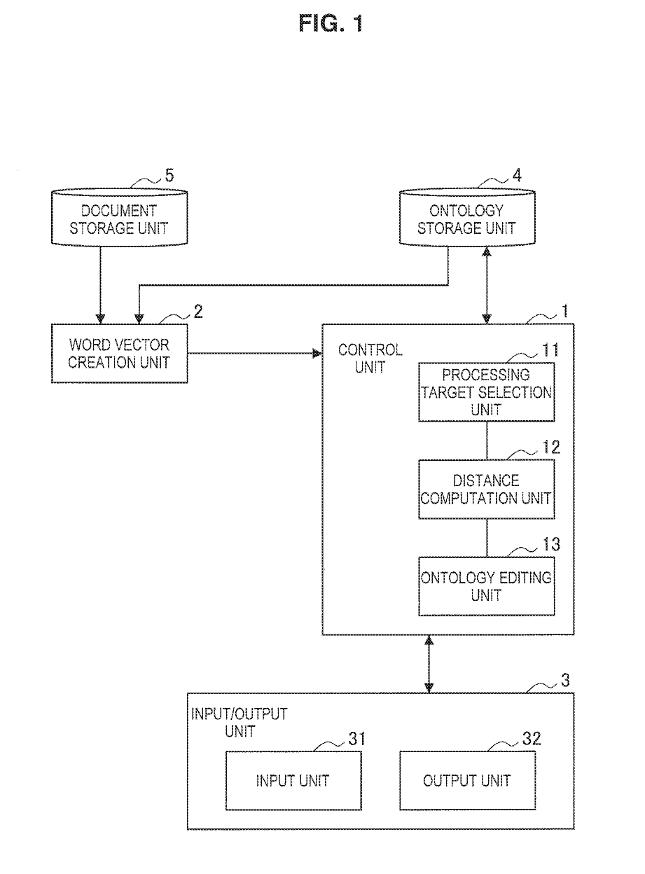

FIG. 1 is a block diagram illustrating the functional configuration of an ontology creation assistance device 100 according to the present embodiment.

The ontology creation assistance device 100 includes a control unit 1, a word vector creation unit 2, an input/output unit 3, an ontology storage unit 4, and a document storage unit 5.

The ontology creation assistance device 100 may be partly or entirely configured with software. For example, the ontology creation assistance device 100 may be configured by installing a program (a program including an ontology processing program according to an embodiment) on a computer (equipped to a processor and a memory, and configured to execute a program). For example, in FIG. 1, the control unit 1 and the word vector creation unit 2 may be configured as programs (programs including an ontology processing program according to an embodiment) on a computer that is not illustrated, while the ontology storage unit 4 and the document storage unit 5 may be configured as data recording media (storage means such as a hard disk drive and a flash memory) of a computer that is not illustrated.

The ontology storage unit 4 serving as an ontology storage means is a storage means for storing the ontology made of a plurality of words (concepts). The ontology stored in the ontology storage unit 4 can associate superordinate concepts and subordinate concepts of words (concepts) with each other. As long as the ontology stored in the ontology storage unit 4 can associate superordinate concepts and subordinate concepts with each other, the specific data description formats are not limited. A variety of ontology data description formats can be applied.

The document storage unit 5 is a storage means for storing a large amount of document data (files of document data such as text data in a variety of formats).

The word vector creation unit 2 serving as a word vector retaining means creates word vectors (word vectors related to words included in document data) from a large amount of document data in the document storage unit 5, and stores the created word vectors. A specific method for allowing the word vector creation unit 2 to generate word vectors from the document data retained in the document storage unit 5 is not limited. For example, the technique described in Non-Patent Literature 1 can be applied. The word vector creation unit 2 may refer to the words stored in the ontology storage unit 4 along with the word dictionary (not illustrated) in the word vector creation unit 2 when parsing sentences into words.

The control unit 1 has a function of controlling each component of the ontology creation assistance device 100, and includes a processing target selection unit 11, a distance computation unit 12, and an ontology editing unit 13.

The processing target selection unit 11 performs processing of receiving, from a user, the designation of a position (word) at which an addition candidate is searched for on the ontology stored in the ontology storage unit 4.

The distance computation unit 12 performs processing of searching for a word serving as a candidate for an addition to a subordinate concept of the position (word) received by the processing target selection unit 11. Specifically, the distance computation unit 12 first performs processing (processing of a seed word acquisition unit) of acquiring, from the ontology storage unit 4, a word corresponding to a subordinate concept of a designated word (concept) as a word (which will be referred to as “seed word”) serving as a seed of an addition candidate. In addition, the distance computation unit 12 performs processing (processing of the distance computation unit) of computing the distance between the hyperplane obtained from a result of fitting processing (e.g. fitting processing using similar computation to principal component analysis) on a plurality of seed words and the words of the respective word vectors retained in the word vector creation unit 2. The distance computation unit 12 further performs processing (processing of an addition candidate extraction unit) of extracting a word serving as a candidate that is additionally registered in the ontology of the ontology storage unit 4 from the words of the word vectors retained in the word vector creation unit 2 on the basis of the computed distance.

The ontology editing unit 13 serving as an ontology editing means performs processing of receiving, from a user, the designation of a word that is added to the ontology of the ontology storage unit 4, from the addition candidate words. The ontology editing unit 13 then performs processing of adding a part or all of the addition candidate words to the ontology of the ontology storage unit 4 in accordance with the instruction (operation) of the user.

The input/output unit 3 has the function (input/output means) of a user interface, and includes an input unit 31 for receiving an operation and an information input from a user, and an output unit 32 for outputting information to a user. As the input unit 31, for example, an input device such as a keyboard and a mouse can be applied. As the output unit 32, an output device such as a display and a printer can be applied.

### (A-2) Operation According to Embodiment

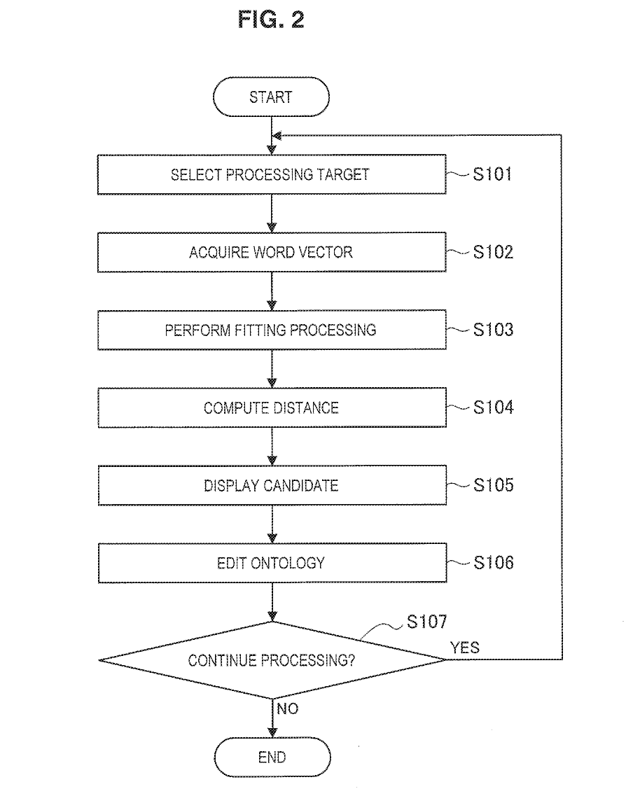

Next, the operation of the ontology creation assistance device 100 according to the present embodiment configured as described above will be described with reference to the flowchart of FIG. 2.

It is assumed in the flowchart of FIG. 2 as a prerequisite condition (initial state) that the word vector creation unit 2 has completed creating word vectors (creating word vectors by using the document data in the document storage unit 5), and the data of the created word vectors has been retained. Similar processing to that of Non-Patent Literature 1 can be applied as discussed above to the processing performed by the word vector creation unit 2 to create word vectors. The detailed description will be thus omitted.

In addition, it is assumed in the flowchart of FIG. 2 as a prerequisite condition (initial state) that ontology made of a given number of words (concepts) has been registered in the ontology storage unit 4.

The processing target selection unit 11 receives, from a user, the designation (selection) of a position (word) at which a word of a subordinate concept is added on the ontology of the ontology storage unit 4 (S101).

For example, the processing target selection unit 11 may present the words (concepts) included in the ontology of the ontology storage unit 4 to a user via the input/output unit 3 (e.g. displays a list or map of the words included in the ontology) to receive the designation (selection) of any word (concept).

Next, the processing target selection unit 11 acquires a seed word that serves as a seed for extracting an addition candidate word, on the basis of the concept (word) designated in step S101. The processing target selection unit 11 then acquires, from the word vector creation unit 2, the word vector of the seed word acquired in the step S101 (S102). Although there is the possibility that the word vector creation unit 2 does not have the corresponding word vectors, the processing target selection unit 11 may acquire the word vectors in the word vector creation unit 2 in that case.

In the present embodiment, the processing target selection unit 11 acquires, from the ontology stored in the ontology storage unit 4, a concept (word) that is one level subordinate to the concept designated by a user in step S101. However, if a concept that is one level subordinate to the designated concept is an intermediate concept, the processing target selection unit 11 acquires (refers to), as a subordinate concept, a concept that is further one level subordinate to the intermediate concept.

The following describes an example in which a user designates the concept (word) “program language” from the concepts (words) stored in the ontology storage unit 4.

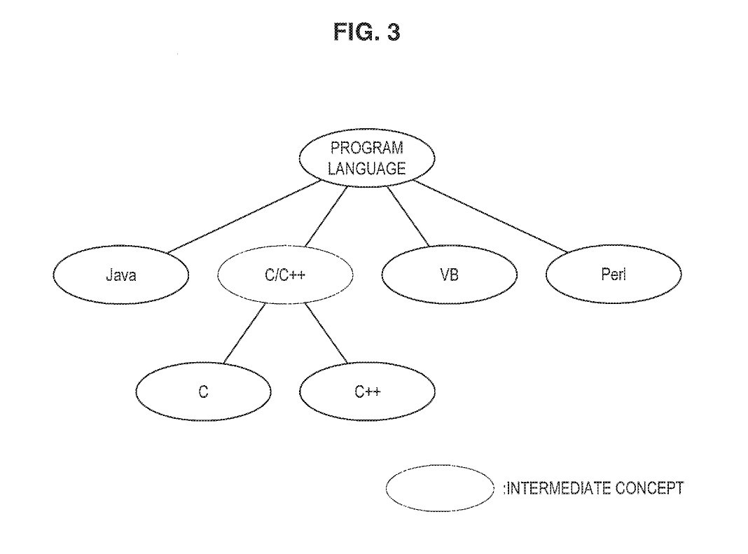

FIG. 3 is an explanatory diagram illustrating an example in which the processing target selection unit 11 acquires a seed word from the concept “program language.” The example of FIG. 3 has the concepts “Java (registered trademark),” “C/C++,” “VB,” and “Perl” as concepts that are one level subordinate to the program language. FIG. 3 illustrates an example in which “C/C++” is an intermediate concept, and has “C” and “C++” as concepts that are one level subordinate to “C/C++.” The processing target selection unit 11 thus acquires “C” and “C++,” which are one level subordinate to the intermediate concept “C/C++,” as a part of the seed words corresponding to “program language.” In the example of FIG. 3, the processing target selection unit 11 thus acquires “Java,” “C,” “C++,” “VB,” and “Perl” as seed words corresponding to the concept “program language.” The processing target selection unit 11 then acquires the word vector of each seed word corresponding to “program language” from the word vector creation unit 2.

Next, the distance computation unit 12 rotates coordinates in a manner that the coordinates fit the distribution of each word vector (the word vector corresponding to each of the extracted seed words) acquired in step S102, and uses a result to decide an M-dimensional hyperplane based on each word vector (S103).

The following describes a specific example of the processing performed by the distance computation unit 12 to decide the M-dimensional hyperplane on the basis of each seed word.

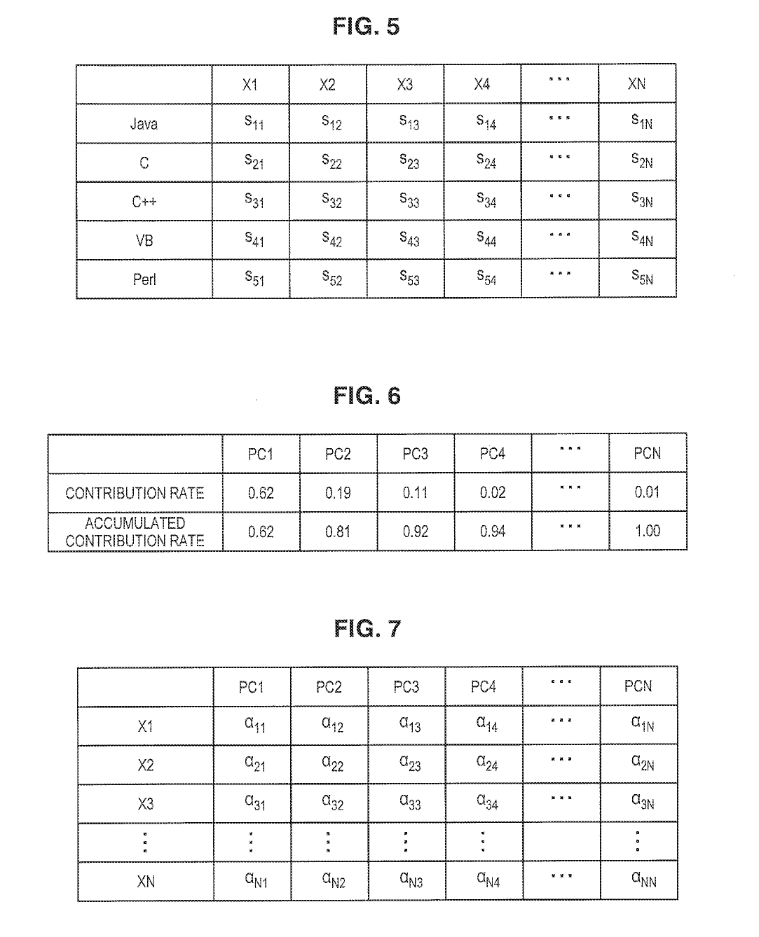

First of all, it is assumed that the word vector creation unit 2 has created N-dimensional vectors (where n represents an integer greater than or equal to 1) as word vectors. Accordingly, the word vectors corresponding to seed words selected by the processing target selection unit 11 can be shown in matrix (table) as illustrated in FIG. 5. The seed words are assigned to the respective columns in the matrix (table) of FIG. 5. In FIG. 5, “Java,” “C,” “C++,” “VB,” and “Perl” are assigned to the respective columns, starting from the first column. In the matrix (table) of FIG. 5, parameters X1, X2, X3, XN are assigned to the respective rows, starting from the first row.

At this time, the data of FIG. 5 is shown in matrix like an expression (1). In this case, the distance computation unit 12 obtains the variance-covariance matrix of the matrix according to the expression (1), and further obtains the eigenvalues and eigenvectors. The distance computation unit 12 then arranges the eigenvectors in descending order by eigenvalue as a rotation matrix (see FIG. 7). The distance computation unit 12 divides each eigenvalue by the total sum of the eigenvalues to calculate a contribution rate. The distance computation unit 12 cumulatively adds contribution rates in descending order by contribution rate to calculate the accumulated contribution rates.

$$S = ( \begin{matrix}{s}_{11} & {s}_{12} & {s}_{13} & {s}_{14} & … & {s}_{1 N} \\ {s}_{21} & {s}_{22} & {s}_{23} & {s}_{24} & … & {s}_{2 N} \\ {s}_{31} & {s}_{32} & {s}_{33} & {s}_{34} & … & {s}_{3 N} \\ {s}_{41} & {s}_{42} & {s}_{43} & {s}_{44} & … & {s}_{4 N} \\ {s}_{51} & {s}_{52} & {s}_{53} & {s}_{54} & … & {s}_{5 N}\end{matrix} ) \qquad ( 1 )$$

FIG. 6 illustrates an example of the contribution rates of the components (a first component PC1, a second component PC2, . . . a N-th component PCN) obtained as a result of processing the respective seed word vectors, and the accumulated contribution rates of the respective components (the accumulated values (total values) of the contribution rates of the first components to the component). FIG. 7 is a matrix illustrating the transform coefficients corresponding to the respective combinations of parameters (X1 to XN) with the components (PC1 to PCN) constituting the word vectors. The transform coefficient corresponding to the combination of a parameter Xi (i represents any of 1 to N) with a component PCj (j represents any of 1 to N) will be referred to as aᵢⱼ. For example, the transform coefficient corresponding to the combination of X1 with PC1 is referred to as a₁₁, and the transform coefficient corresponding to the combination of X1 with PC2 is referred to as a₁₂.

Next, the distance computation unit 12, in a fitting result, refers to the accumulated contribution rates, starting from that of the first component PC1. The distance computation unit 12 then acquires the number M of dimensions at which a predetermined accumulated contribution rate T is first exceeded (the number (order) of the component at which the accumulated contribution value T serving as the threshold is first exceeded). Although it is here assumed as an example that the accumulated contribution rate T is 80% (0.80), the accumulated contribution rate T can have any value.

For example, in the fitting result illustrated in FIG. 6, referring to the accumulated contribution rates starting from that of the first component PC1 shows that it is the accumulated contribution rate of the second component PC2 that first exceeds 80% (0.80). The distance computation unit 12 thus acquires “2” as the number M of dimensions.

Next, the distance computation unit 12 decides the hyperplane formed between a first axis (the axis of the first component) and an M-th axis (the axis of an M-th component) as an M-dimensional hyperplane to be obtained. Since M=2 as discussed above, the distance computation unit 12 decides the hyperplane formed between the first and second axes as the M-dimensional hyperplane to be obtained.

As described above, the distance computation unit 12 decides the M-dimensional hyperplane.

Next, the distance computation unit 12 computes the distance between the M-dimensional hyperplane decided in step S103 and the point indicated by each word vector in the word vector creation unit 2 (S104).

The following describes a specific example of the processing performed by the distance computation unit 12 to compute the distance between the M-dimensional hyperplane and each word vector.

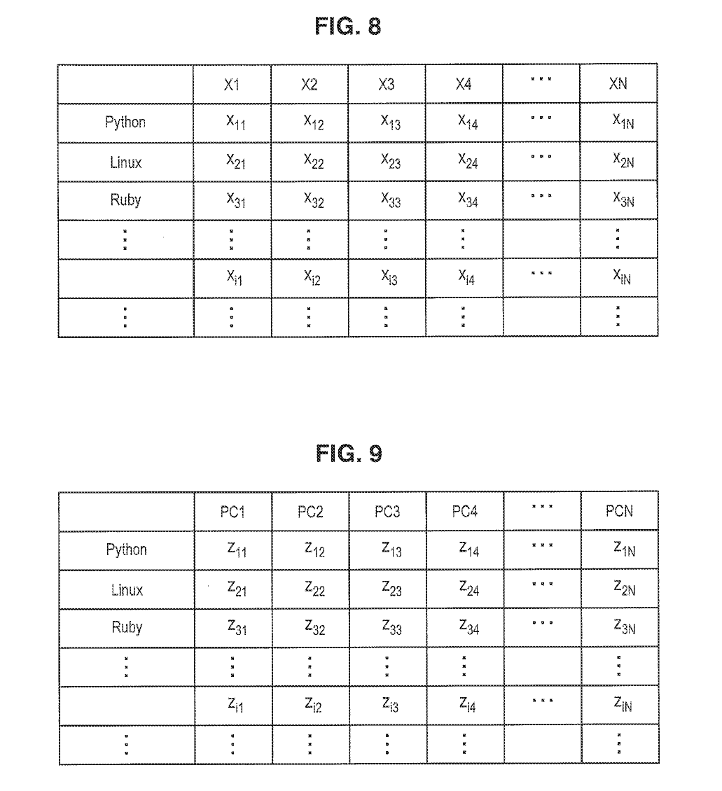

FIG. 8 is an explanatory diagram illustrating an example of each word vector in the word vector creation unit 2.

FIG. 8 illustrates parameters (X1 to XN) of the word vectors corresponding to the words “python,” “Linux (registered trademark),” “Ruby,” . . . .

FIG. 8 illustrates the values of the parameters X1 to XN corresponding to the word “python” as x₁₁ to x_{1N}. In addition, FIG. 8 illustrates the values of the parameters X1 to XN corresponding to the word “Linux” as x₂₁ to x_{2N}. FIG. 8 further illustrates the values of the parameters X1 to XN corresponding to the word “Ruby” as X₃₁ to X_{3N}.

FIG. 9 is an explanatory diagram illustrating a result obtained by rotating the coordinates of each word vector illustrated in FIG. 8. The following refers to a result obtained by rotating the coordinates of a word vector as “rotation result vector.”

FIG. 9 illustrates the word vectors corresponding to the words “python,” “Linux,” “Ruby,” . . . with the parameters (the first component PC1 to the N-th component PCN) of rotation result vectors.

FIG. 9 illustrates the values of the first component PC1 to the N-th component PCN corresponding to the word “python” as z₁₁ to z_{1N}. FIG. 9 illustrates the values of the first component PC1 to the N-th component PCN corresponding to the word “Linux” as z₂₁ to z_{2N}. Furthermore, FIG. 9 illustrates the values of the first component PC1 to the N-th component PCN corresponding to the word “Ruby” as z₃₁ to z_{3N}. Still furthermore, FIG. 9 illustrates the values of the first component PC1 to the N-th component PCN corresponding to a given word as zᵢ₁ to z_{iN} (i represents an integer greater than or equal to 1). Additionally, it is possible to obtain the values (zᵢ₁ to z_{iN}) of the first components PC1 to the N-th component PCN corresponding to each word in accordance with the matrix operation shown in the following expression (2). In the expression (2), A represents the matrix shown in the following expression (3). In the expression (2), X represents the matrix shown in the following expression (4). Furthermore, in the expression (2), Z represents the matrix shown in the following expression (5).

$$\begin{matrix}Z = XA & ( 2 ) \\ A = ( \begin{matrix}{a}_{11} & {a}_{12} & {a}_{13} & {a}_{14} & … & {a}_{1 N} \\ {a}_{21} & {a}_{22} & {a}_{23} & {a}_{24} & … & {a}_{2 N} \\ {a}_{31} & {a}_{32} & {a}_{33} & {a}_{34} & … & {a}_{3 N} \\ ⋮ & ⋮ & ⋮ & ⋮ & & ⋮ \\ {a}_{N 1} & {a}_{N 2} & {a}_{N 3} & {a}_{N 4} & … & {a}_{NN}\end{matrix} ) & ( 3 ) \\ X = ( \begin{matrix}{x}_{11} - {c}_{1} & {x}_{12} - {c}_{2} & {x}_{13} - {c}_{3} & {x}_{14} - {c}_{4} & … & {x}_{1 N} - {c}_{N} \\ {x}_{21} - {c}_{1} & {x}_{22} - {c}_{2} & {x}_{23} - {c}_{3} & {x}_{24} - {c}_{4} & … & {x}_{2 N} - {c}_{N} \\ {x}_{31} - {c}_{1} & {x}_{32} - {c}_{2} & {x}_{33} - {c}_{3} & {x}_{34} - {c}_{4} & … & {x}_{3 N} - {c}_{N} \\ ⋮ & ⋮ & ⋮ & ⋮ & & ⋮ \\ {x}_{i 1} - {c}_{1} & {x}_{i 2} - {c}_{2} & {x}_{i 3} - {c}_{3} & {x}_{i 4} - {c}_{4} & … & {x}_{iN} - {c}_{N} \\ ⋮ & ⋮ & ⋮ & ⋮ & & ⋮\end{matrix} ) & ( 4 )\end{matrix}$$

where cⱼ represents the average value of x₁ⱼ, x₂ⱼ, x₃ⱼ, . . . xᵢⱼ, . . .

$$Z = ( \begin{matrix}{z}_{11} & {z}_{12} & {z}_{13} & {z}_{14} & … & {z}_{1 N} \\ {z}_{21} & {z}_{22} & {z}_{23} & {z}_{24} & … & {z}_{2 N} \\ {z}_{31} & {z}_{32} & {z}_{33} & {z}_{34} & … & {z}_{3 N} \\ ⋮ & ⋮ & ⋮ & ⋮ & & ⋮ \\ {z}_{i 1} & {z}_{i 2} & {z}_{i 3} & {z}_{i 4} & … & {z}_{iN} \\ ⋮ & ⋮ & ⋮ & ⋮ & & ⋮\end{matrix} ) \qquad ( 5 )$$

The distance computation unit 12 can thus obtain the distance between the M-dimensional hyperplane and a given word (word vector) from the sum of squares of the (M+1)-th component and the subsequent components of the parameters of the rotation result vectors illustrated in FIG. 9.

Specifically, the distance computation unit 12 can obtain the distance between the M-dimensional hyperplane and a given word (i-th word) in accordance with an expression (6). For example, if M=2, a distance D1 of the word “Python” illustrated in FIGS. 8 and 9 can be represented as shown in an expression (7).

Dᵢ=z_{iM+1}²+z_{iM+2}²+z_{iM+3}²+ . . . +z_{iN}² (6)

D₁=z₁₃²+z₁₄²+z₁₅²+ . . . +z_{1N}² (7)

As described above, the distance computation unit 12 obtains the distance between the M-dimensional hyperplane and each word vector (the word vector other than a seed word) in the word vector creation unit 2.

Next, the ontology editing unit 13 extracts an addition candidate word on the basis of the distance of each word computed in step S104, and presents an extraction result to a user (e.g. displays and outputs an extraction result to a user via the input/output unit 3) (S105).

Next, the ontology editing unit 13 receives the admission or denial of the addition of the addition candidate word from the user (e.g. receives an input via the input/output unit 3), and additionally registers the word the admission of the addition of which is input in the ontology of the ontology storage unit 4 (S106).

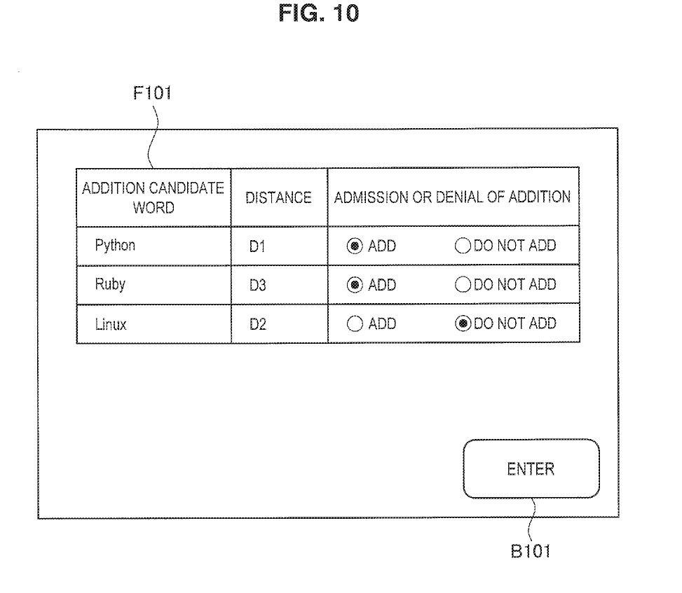

For example, the ontology editing unit 13 may also extract, as an addition candidate, a word having a less (shorter) distance than a predetermined threshold, and present the extracted word to a user. For example, the ontology editing unit 13 may also receive the admission or denial (“add” or “do not add”) of the addition of each addition candidate word to the ontology by presenting the addition candidate word to a user on the displayed operation screen (GUI screen) as illustrated in FIG. 10 via the input/output unit 3. The ontology editing unit 13 may also attach information on the computed distance to each addition candidate word, and then present each addition candidate word to a user as illustrated in FIG. 10.

There are a field F101 and an enter button B101 disposed on the operation screen of FIG. 10. The field F101 has a distance and radio buttons that allow a user to select the admission or denial of the addition of each addition candidate word (radio buttons that allow a user to select “add” or “do not add”). The enter button B101 is used to decide a word that is added to the ontology. Once the enter button B101 is pushed down on the operation screen of FIG. 10, the ontology editing unit 13 additionally registers a word “add” of which is selected in the field F101 (a word “add” of which is selected via the radio button) in the ontology of the ontology storage unit 4 (additionally registers a word “add” of which is selected in the field F101 as a subordinate concept of a concept (word) designated by the user). In FIG. 10, the words are disposed in ascending (increasing) order of distance in the field F101. Arranging (sorting) the words in the field F101 in the order according to the distances allows a user to select a word having a concept closer to the designated concept (“program language” in this case) as a subordinate concept.

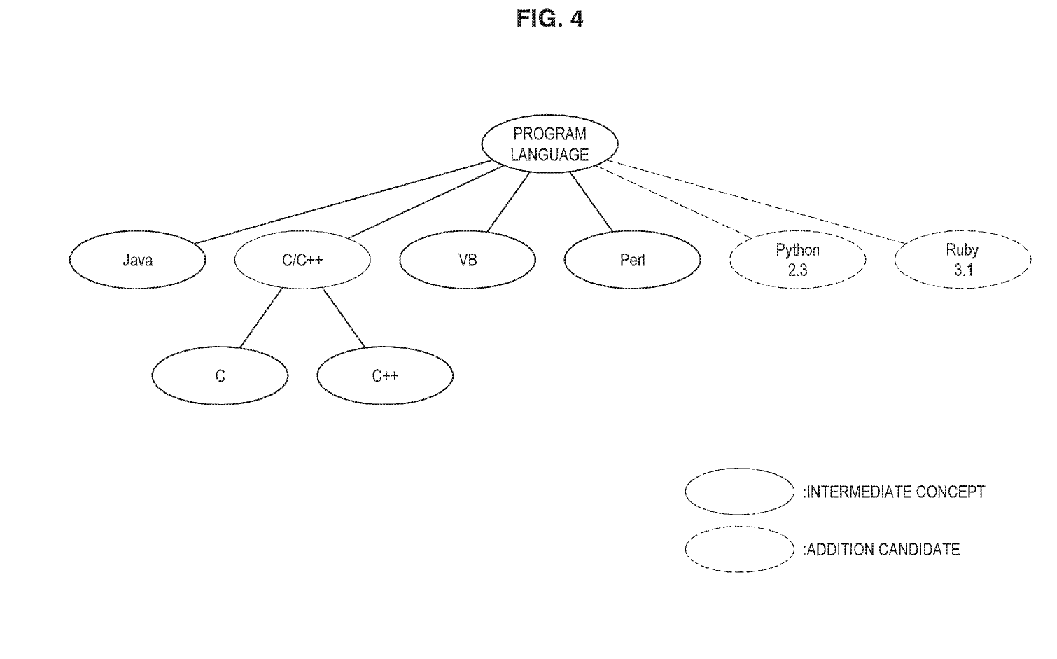

The three words “python,” “Linux,” and “Ruby” are displayed on the operation screen of FIG. 10 as addition candidate words. In FIG. 10, “add” is selected (selected via the radio button) for the two words “python” and “Ruby.” Accordingly, once the enter button B101 is pushed down on the operation screen of FIG. 10, the ontology editing unit 13 additionally registers the two words “python” and “Ruby” in the ontology of the ontology storage unit 4 as illustrated in FIG. 4.

Compared with FIG. 3, the two words “python” and “Ruby” are registered in the ontology illustrated in FIG. 4 as subordinate concepts of the program language.

Next, the control unit 1 is notified by a user whether or not the user continues the processing (S107). If the control unit 1 is notified that the user continues the processing, the control unit 1 operates starting from step S101 described above. If the control unit 1 is notified that the user does not continue the processing, the control unit 1 terminates the processing.

### (A-3) Advantageous Effects According to Embodiment

According to the present embodiment, the following advantageous effects can be attained.

If words (concepts) have been registered in the ontology of the ontology storage unit 4 to some extent, the ontology creation assistance device 100 according to the present embodiment can automatically extract an addition candidate word by using the registered words as seed words.

The ontology creation assistance device 100 according to the present embodiment calculates the distance from the M-dimensional hyperplane decided on the basis of a result of fitting processing on the word vectors of seed words, and extracts an addition candidate word on the basis of the calculated distance. This allows the ontology creation assistance device 100 according to the present embodiment to focus on not the overall similarity, but the similarity from some perspective, and to add a new word to the ontology having existing superordinate concepts and subordinate concepts.

Furthermore, since the ontology creation assistance device 100 according to the present embodiment displays the distance value of an extracted addition candidate along with a word (see FIG. 10), it is possible to finally decide in accordance with an operation of a user whether to add the addition candidate to the ontology.

### (B) Other Embodiments

The present invention is not limited to the above-described embodiment. The following example modification can be included.

(B-1) An example has been described in the above-described embodiment in which the word vector creation unit 2 is applied. The word vector creation unit 2 creates a word vector from document data and retains the created word vector as a word vector retaining unit. The methods for the ontology creation assistance device 100 to retain a word vector based on document data are not, however, limited in particular. For example, a means for retaining a word vector that is generated on the outside may be applied in the above-described embodiment instead of the word vector creation unit 2.

The program of the embodiments may be stored in a non-transitory computer readable medium, such as a flexible disk or a CD-ROM, and may be loaded onto a computer and executed. The recording medium is not limited to a removable recording medium such as a magnetic disk or an optical disk, and may be a fixed recording medium such as a hard disk apparatus or a memory. In addition, the program of the embodiments may be distributed through a communication line (also including wireless communication) such as the Internet. Furthermore, the program may be encrypted or modulated or compressed, and the resulting program may be distributed through a wired or wireless line such as the Internet, or may be stored a non-transitory computer readable medium and distributed.

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

What is claimed is:

1. An ontology processing device comprising:
a word vector retaining unit configured to retain a plurality of word vectors;
an ontology storage unit configured to store ontology;
a seed word acquisition unit configured to acquire a word from the ontology stored in the ontology storage unit as a seed word, the word corresponding to a subordinate concept of a designated word;
a distance computation unit configured to compute a distance between a hyperplane obtained from a result of fitting processing on the seed word and a word corresponding to each of the word vectors retained in the word vector retaining unit;
an addition candidate extraction unit configured to extract words serving as candidates from words corresponding to the plurality of word vectors retained in the word vector retaining unit on the basis of the distance computed by the distance computing unit, the candidates being additionally registered in the ontology of the ontology storage unit; and
an ontology editing unit configured to add a part or all of addition candidate words to the ontology of the ontology storage unit, the addition candidate words being extracted by the addition candidate extraction unit.

2. The ontology processing device according to claim 1, wherein
the ontology editing unit
presents, to a user, the addition candidate words extracted by the addition candidate extraction unit,
receives designation of a word from the user, the word being added to the ontology, and
adds, to the ontology, the word designated by the user as a word that is added to the ontology.

3. The ontology processing device according to claim 1, wherein
the distance computation unit
decides a number M (M represents an integer greater than or equal to 1) of dimensions of the hyperplane on the basis of the result of fitting processing on the seed word, and
computes, as a distance corresponding to a word of each of the word vectors retained in the word vector retaining unit, a distance between the hyperplane formed between a first axis to an M-th axis and a point indicated by each of the word vectors retained in the word vector retaining unit.

4. A non-transitory computer-readable storage medium storing an ontology processing program, the program causing a computer to function as:
a word vector retaining unit configured to retain a plurality of word vectors;
an ontology storage unit configured to store ontology;
a seed word acquisition unit configured to acquire a word from the ontology stored in the ontology storage unit as a seed word, the word corresponding to a subordinate concept of a designated word;
a distance computation unit configured to compute a distance between a hyperplane obtained from a result of fitting processing on the seed word and a word corresponding to each of the word vectors retained in the word vector retaining unit;
an addition candidate extraction unit configured to extract words serving as candidates from words corresponding to the plurality of word vectors retained in the word vector retaining unit on the basis of the distance computed by the distance computing unit, the candidates being additionally registered in the ontology of the ontology storage unit; and
an ontology editing unit configured to add a part or all of addition candidate words to the ontology of the ontology storage unit, the addition candidate words being extracted by the addition candidate extraction unit.
